(19) United States
(12) Patent Application Publication
(10) Pub. No.: US 2025/0307583 A1
(43) Pub. Date: Oct. 2, 2025

(54) INSPECTION APPARATUS AND METHOD OF CONTROLLING THE SAME

(71) Applicant: CANON KABUSHIKI KAISHA, Tokyo (JP)

(72) Inventor: MASAAKI MURAISHI, Chiba (JP)

(21) Appl. No.: 19/081,365

(22) Filed: Mar. 17, 2025

(30) Foreign Application Priority Data
Mar. 27, 2024 (JP) 2024-052130

(51) Int. Cl. G06K 15/02; G06K 15/00; G06T 7/00; H04N 1/00

(52) U.S. Cl. CPC G06K 15/027; G06K 15/007; G06K 15/1881; G06T 7/0004; H04N 1/00795; G06T 2207/30144; H04N 2201/0094

(57) ABSTRACT

An inspection apparatus obtains a scanned image obtained by reading a printed material with an image reading unit, inspects the printed material based on the scanned image and a reference image, and sets an inspection region to be a target of the inspection and an inspection level for the inspection region. The inspection apparatus displays a first inspection region, for which a first inspection level has been set in the setting, so as to be surrounded by a frame line of a first thickness, and displays a second inspection region, for which a second inspection level different from the first inspection level has been set in the setting, so as to be surrounded by a frame line of a thickness different from the first thickness.

### BACKGROUND OF THE INVENTION

### Field of the Invention

The present invention relates to an inspection apparatus and a method of controlling the same.

### Description of the Related Art

Conventionally, inspection for confirming whether a printed material has been correctly printed is performed manually, but in recent years, an inspection apparatus for performing inspection automatically as post-processing of a printer has been used. In such an inspection apparatus, reference image data, which is correct data, is registered in advance. Then, a printed material on which printing has been performed on a sheet by an image forming apparatus is generated based on inputted image data, and an image printed on that printed material is optically read by a sensor arranged inside the inspection apparatus. Then, a defect of the printed material is detected by comparing image data read by the sensor with the registered reference image data. In the following, inspection for detecting a defect in a pattern portion of a printed material will be referred to as printed image inspection.

In printed image inspection, since required quality varies depending on the business form of the user and the printed material, it is important to carry out inspection that is necessary and sufficient for inspection requirements. If an inspection level is too lenient, printed materials containing defects will be shipped, and if an inspection level is too strict, printed materials that would not have been deemed defective will end up being deemed defective. This results in an increase in the number of discarded sheets as well as a burden on the user to visually confirm whether there is a defect in printed materials determined to be defective.

In order to solve such a problem, Japanese Patent Laid-Open No. 2021-078082 describes a method of arranging a plurality of inspection regions having different inspection levels from each other in a printed material and performing printed image inspection.

In the method of Japanese Patent Laid-Open No. 2021-078082, in order to distinguish inspection levels of a plurality of inspection regions, the inspection regions are drawn with the colors of the frames of the inspection regions changed to correspond to inspection levels corresponding to the inspection regions. However, in such a method, there is a problem that, when a large number of inspection regions having different inspection levels from each other are arranged, it is difficult to distinguish between the inspection levels based on the colors of the frames of the inspection regions.

### SUMMARY OF THE INVENTION

Embodiments of the present disclosure eliminate the above-mentioned issues with conventional technology.

A feature of embodiments of the present disclosure is to provide a technique for allowing it to be easily distinguished which inspection level is applied to each inspection region even when a large number of inspection regions having different inspection levels from each other are arranged.

According to embodiments of the present disclosure, there is provided an inspection apparatus comprising: one or more controllers including one or more processors and one or more memories, the one or more controllers configured to: obtain a scanned image obtained by reading a printed material with an image reading unit; inspect the printed material based on the scanned image and a reference image; set an inspection region to be a target of the inspection and an inspection level for the inspection region; and display a first inspection region, for which a first inspection level has been set in the setting, so as to be surrounded by a frame line of a first thickness, and display a second inspection region, for which a second inspection level different from the first inspection level has been set in the setting, so as to be surrounded by a frame line of a thickness different from the first thickness.

According to embodiments of the present disclosure, there is provided an inspection apparatus comprising: one or more controllers including one or more processors and one or more memories, the one or more controllers configured to: obtain a scanned image obtained by reading a printed material with an image reading unit; inspect the printed material based on the scanned image and a reference image; set an inspection region to be a target of the inspection and an inspection level for the inspection region; and display information of a first inspection level near a first inspection region, for which the first inspection level has been set in the setting, and display information of a second inspection level near a second inspection region, for which the second inspection level has been set in the setting.

According to embodiments of the present disclosure, there is provided a method of controlling an inspection apparatus configured to receive a printed material and perform inspection, the method comprising: obtaining a scanned image obtained by reading a printed material with an image reading unit; inspecting the printed material based on the scanned image and a reference image; setting an inspection region to be a target of the inspection and an inspection level for the inspection region; and displaying a first inspection region, for which a first inspection level has been set in the setting, so as to be surrounded by a frame line of a first thickness, and displaying a second inspection region, for which a second inspection level different from the first inspection level has been set in the setting, so as to be surrounded by a frame line of a thickness different from the first thickness.

Further features of the present disclosure will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the disclosure and, together with the description, serve to explain the principles of the disclosure.

FIG. 1 is a diagram for explaining a configuration of an inspection system including an inspection apparatus according to a first embodiment of the present invention.

FIG. 2 is a block diagram for describing a hardware configuration of the image forming apparatus according to the first embodiment.

FIG. 3 is a block diagram for describing a hardware configuration of the inspection apparatus according to the first embodiment.

FIG. 4 is a flowchart for explaining a flow of inspection processing by the inspection apparatus according to the first embodiment.

FIG. 5 is a diagram illustrating an example of a job management screen to be displayed on a UI unit of the inspection apparatus according to the first embodiment.

FIG. 6 is a diagram illustrating an example of an inspection setting screen to be displayed on the UI unit of the inspection apparatus according to the first embodiment.

FIG. 7 is a flowchart for explaining inspection setting processing of step S403 of FIG. 4.

FIGS. 8A to 8C are diagrams illustrating examples of inspection regions displayed in a reference image of the inspection setting screen according to the first embodiment.

FIGS. 9A to 9D are diagrams illustrating examples of cases where, in addition to displaying inspection level information in a superimposed manner on the upper right of inspection regions, the frames of inspection regions and the display forms of inspection regions are changed according to the inspection levels, in the first embodiment.

FIG. 10 is a diagram illustrating an example of an inspection result confirmation screen to be displayed after inspection execution has been completed in the first embodiment.

FIG. 11 is a diagram illustrating an example of an inspection setting screen to be displayed on the UI unit of the inspection apparatus according to a second embodiment.

FIG. 12 is a flowchart for explaining inspection setting processing according to a third embodiment.

FIG. 13 is a flowchart for explaining display form allocation processing in step S1201 of FIG. 12.

FIGS. 14A to 14C are diagrams illustrating examples of allocation of display forms of inspection regions according to the third embodiment.

### DESCRIPTION OF THE EMBODIMENTS

Embodiments of the present disclosure will be described hereinafter in detail, with reference to the accompanying drawings. It is to be understood that the following embodiments are not intended to limit the claims of the present disclosure, and that not all of the combinations of the aspects that are described according to the following embodiments are necessarily required with respect to the means to solve the issues according to the present disclosure. Further, in the accompanying drawings, the same or similar configurations are assigned the same reference numerals, and redundant descriptions are omitted. Note that in the following description, an image forming apparatus is also called a multi-function peripheral (MFP) in some cases.

### First Embodiment

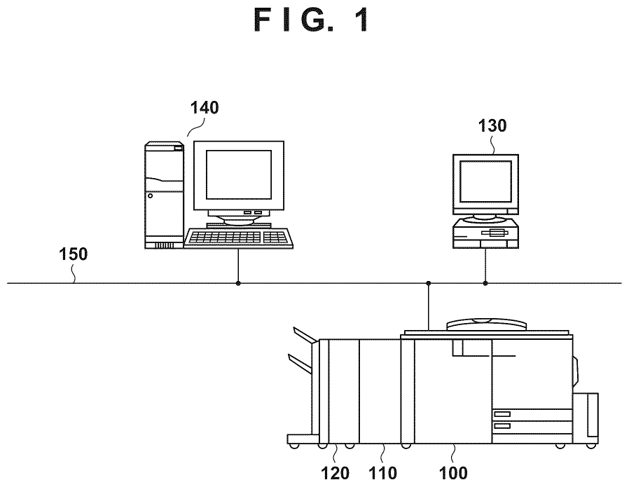

FIG. 1 is a diagram for explaining a configuration of an inspection system including an inspection apparatus according to a first embodiment of the present invention.

The inspection system includes an image forming system including an image forming apparatus 100, an inspection apparatus 110, and a finisher 120, and a client PC 130 and a print server 140 are connected to the image forming system through a network 150.

The image forming apparatus 100 prints an image or the like on a sheet based on various kinds of input data, such as print data transmitted from the client PC 130 or the print server 140, and discharges it as a printed material.

The image forming apparatus 100 will be described as an image forming apparatus in the embodiments but is not limited thereto and need only be a recording apparatus (printing apparatus) that performs recording (printing) on a recording medium. Further, for example, it may be a recording apparatus for performing recording on metal.

The inspection apparatus 110 receives a printed material outputted from the image forming apparatus 100 and inspects whether there is a defect in the received printed material. Here, a defect is something that decreases the quality of a printed material and includes, for example, a stain caused by a coloring material adhering to unintended portions when printing, color omission caused by a coloring material not sufficiently adhering to an intended portion, or the like.

Further, in variable printing which includes a variable region such as a character string or a barcode, the inspection apparatus 110 inspects the variable region. This inspection includes, for example, data legibility inspection for confirming whether a character string or a barcode is legible, data collating inspection for collating a reading result of a character string or a barcode with correct data, and the like. That is, the inspection apparatus 110 can perform printed image inspection for detecting a defect in a pattern portion of a printed material and data inspection including data legibility inspection and data collating inspection. The inspection apparatus 110 does not necessarily need to have an inspection processing unit for performing printed image inspection and data inspection therein, and for example, a configuration may be taken so as to perform such inspection processing by an inspection PC (not illustrated) connected to the inspection apparatus 110 so as to be capable of communication.

The finisher 120 receives a printed material inspected by the inspection apparatus 110 and switches the discharge destination of that printed material based on an inspection result of the inspection apparatus 110. For example, in the case of an inspection OK, the printed material is discharged to a discharge tray 1 (not illustrated), and in the case of an inspection NG, the printed material is discharged to a discharge tray 2 (not illustrated). The finisher 120 executes post-processing (book binding, stapling, etc.) as necessary before discharge.

The image forming apparatus 100 is connected to the client PC 130 and the print server 140 through the network 150 and is further connected to the inspection apparatus 110 and the finisher 120 through a communication cable. The inspection apparatus 110 is connected to the finisher 120 through the communication cable, in addition to the image forming apparatus 100. In the embodiments, description will be given using as an example an in-line inspection apparatus, which allows image forming (printing), inspection, post-processing, and discharge to be performed from start to finish, but the present invention is not intended to be limited.

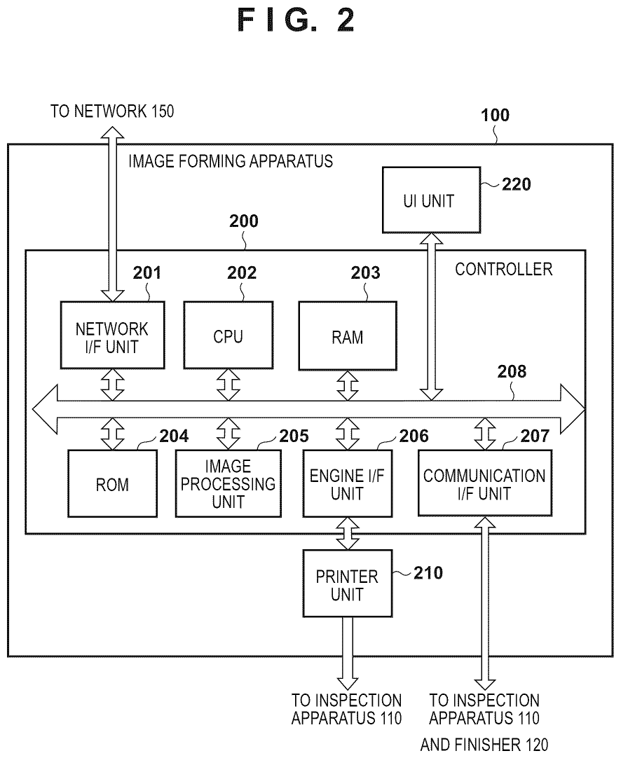

FIG. 2 is a block diagram for describing a hardware configuration of the image forming apparatus 100 according to the first embodiment.

A controller 200 receives image data and document data from the network 150 and converts the received image data and document data to print data. A printer unit 210 generates a printed material for which print data has been printed on a recording sheet (paper, sheet). A UI unit 220 receives an instruction such as display of a screen and selection of sheet information for the image forming apparatus 100 from the user. The image forming apparatus 100 includes the above controller 200, printer unit 210, and UI unit 220.

Next, a configuration of the controller 200 will be described.

A network interface (I/F) unit 201 transmits and receives data to from the client PC 130 and the print server 140 through the network 150. A CPU 202 controls the entire image forming apparatus 100. A RAM 203 is used as an area for deploying a program to be executed by the CPU 202 and as a work area when the CPU 202 executes various instructions. A ROM 204 stores program data to be executed by the CPU 202 at startup, setting data of the controller 200, and the like. An image processing unit 205 performs raster image processer (RIP) processing for converting image data and document data received from the network 150 to print data. The RIP processing does not need to be performed by the image processing unit 205, and a configuration may be taken such that the RIP processing is performed by, for example, an information processing apparatus (not illustrated) connected to the image forming apparatus 100 so as to be capable of communication. The functions of the image processing unit 205 may be realized by the CPU 202 deploying a program stored in the ROM 204 to the RAM 203 and executing the program.

An engine I/F (interface) unit 206 transmits print data to the printer unit 210 and transmits the status of the printer unit 210 to the CPU 202. A communication I/F unit 207 communicates with the inspection apparatus 110 and the finisher 120 through the above communication cable. Here, communication for inspection-related information, such as an inspection result, and discharge control are carried out. The above respective units of the controller 200 are connected via an internal bus (system bus) 208.

Image data and document data created on the client PC 130 or the print server 140 are transmitted as PDL data to the image forming apparatus 100 via the network (e.g., local area network) 150. A configuration may be taken such that a job for printing image data, document data, or the like is transmitted to an information processing apparatus (not illustrated) via a network and managed by the information processing apparatus. A configuration may be taken such that a print job is transmitted from the information processing apparatus to the image forming apparatus 100 through the network 150 and the image forming apparatus 100 performs processing for performing printing on a sheet.

PDL data transmitted from the client PC 130 or the print server 140 is stored in the RAM 203 through the network I/F unit 201. A print instruction by the user through the UI unit 220 is also stored in the RAM 203 through the internal bus 208. A print instruction by the user includes, for example, selection of a sheet type. The image processing unit 205 obtains PDL data stored in the RAM 203 and performs image processing for conversion into print data. The image processing for conversion into print data includes performing, for example, rasterization on PDL data, conversion into multi-valued bitmap data, and screen processing or the like, to perform, for example, conversion into binary bitmap data. Binary bitmap data obtained by the image processing unit 205 is transmitted to the printer unit 210 through the engine I/F unit 206.

The printer unit 210 prints the received binary bitmap data on a sheet using color materials. The CPU 202 issues an instruction to the printer unit 210 based on a print instruction by the user stored in the RAM 203. For example, when there is an instruction to print on coated paper from a user, the CPU 202 outputs, to the printer unit 210, an instruction to output a sheet from a paper cassette (not illustrated), in which coated paper is stored, in the image forming apparatus 100. A full color image is formed on a sheet by the CPU 202 controlling the above various processes from receiving PDL data to printing on a sheet.

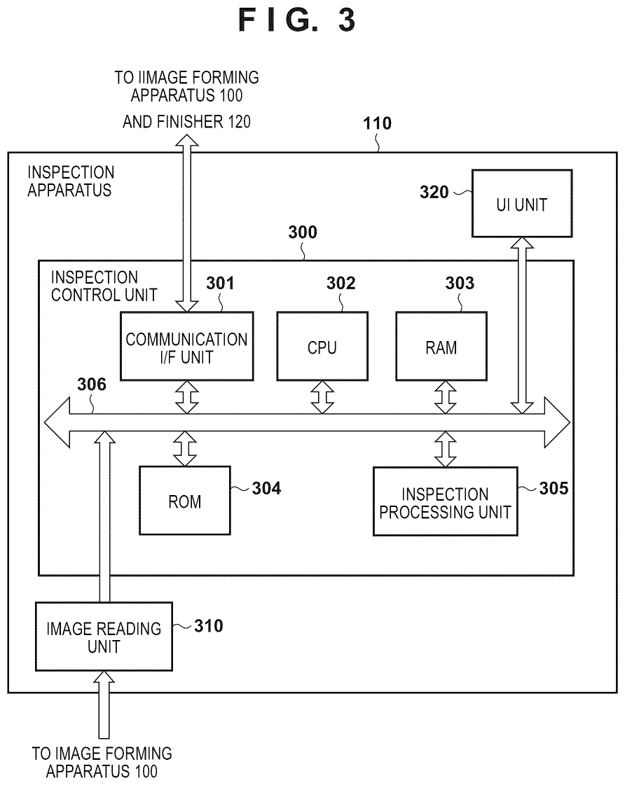

FIG. 3 is a block diagram for explaining a hardware configuration of the inspection apparatus 110 according to the first embodiment.

An inspection control unit 300 controls the entire inspection apparatus 110 and controls inspection processing for inspecting whether there is a defect in a printed material. An image reading unit 310 optically reads a printed material conveyed from the image forming apparatus 100. The image reading unit 310 generates scanned image data (hereinafter, a scanned image) by reading the printed material. A UI unit 320 is a UI unit for the user to set settings for the inspection apparatus 110 and for displaying an inspection result to the user. Here, the settings for the inspection apparatus 110 to set by the user includes an inspection item for setting what defect to inspect for when inspecting a printed material. Here, types of defect include, for example, circular defect (spot), linear defect (streak), and the like. The inspection apparatus 110 includes the inspection control unit 300, the image reading unit 310, and the UI unit 320. In the first embodiment, the UI unit 320 includes a display unit that displays a screen and a display control unit that controls a screen to be displayed on the display unit. Setting of the inspection apparatus 110, display of an inspection result, and the like performed by the UI unit 320 may be performed by an external device such as the above UI unit 220 of the image forming apparatus 100, an inspection PC (not illustrated), or an information processing apparatus (not illustrated).

Next, a configuration of the inspection control unit 300 will be described.

A communication interface (I/F) unit 301 transmits and receives data to from the image forming apparatus 100, and the finisher 120 through the communication cable. A CPU 302 controls the entire inspection apparatus 110. A RAM 303 is used as a work area when the CPU 302 executes various instructions. A ROM 304 stores program data to be executed by the CPU 302 at startup, setting data of the inspection control unit 300, and the like. An inspection processing unit 305 inspects whether there is a defect in a printed material. These components of the inspection control unit 300 are connected via an internal bus 306. The functions of the inspection processing unit 305 may be realized by the CPU 302 deploying a program stored in the ROM 304 to the RAM 303 and executing the program.

Next, an overview of printed image inspection to be performed by the inspection apparatus 110 will be described. The inspection apparatus 110 uses the image reading unit 310 to optically read a printed material conveyed from the image forming apparatus 100 and obtains a scanned image of the inspection target printed material. The scanned image thus obtained is stored in the RAM 303. Then, the inspection apparatus 110 uses the inspection processing unit 305 to compare reference image data (hereinafter, a reference image) stored in advance in the RAM 303 as a correct image with the scanned image of the inspection target and obtains difference values.

Next, the inspection apparatus 110 compares, for each pixel, the difference value with inspection thresholds of respective inspection items (e.g., contrast and size) and thereby performs inspection. Information indicating results of performing inspection is stored in the RAM 303. The information includes, for example, information on whether there is a defect in the printed material, the type of the detected defect (spot or streak), position information of the defect at the time of display on the UI unit 320, and the like.

Next, an overview of data inspection to be performed by the inspection apparatus 110 will be described.

The inspection apparatus 110 uses the image reading unit 310 to read a printed material conveyed from the image forming apparatus 100 and thereby obtains a scanned image of the inspection target. The scanned image thus obtained is stored in the RAM 303. Then, the inspection apparatus 110 uses the inspection processing unit 305 to inspect whether a character string or a barcode is legible using a character font for character recognition (OCR) or a barcode standard that has been set in advance. If legible, an OK determination is made, and if illegible, an NG determination is made. In addition, it is possible to perform data collating inspection for performing collation as to whether a result of a scanned character string or barcode matches corresponding data (correct data) of a correct CSV file provided in advance. Here, similarly, as a result of collation, if the data match, an OK determination is made, if the data do not match, an NG determination is made. The results of performing inspection are stored in the RAM 303, and for example, a result of inspection of a character string or a barcode read from the printed material, a result of collation with correct data, position information of a read character or barcode at the time of display on the UI unit 320, and the like are stored.

Next, the inspection apparatus 110 uses the CPU 302 to instruct the UI unit 320 to display the inspection results stored in the RAM 303. The inspection results are thus displayed on the UI unit 320, and thereby, the user can recognize the inspection results.

If a defective printed material has occurred or a given number of defective printed materials have occurred consecutively, the inspection apparatus 110 uses the CPU 302 to transmit that information to the image forming apparatus 100 through the communication I/F unit 301.

In the image forming apparatus 100, the controller 200 receives information indicating that a defective printed material has occurred through the communication I/F unit 207. When the controller 200 receives this information, the CPU 202 instructs the printer unit 210 to stop printing. The image forming apparatus 100 thus stops the printing operation.

Further, the inspection apparatus 110 uses the CPU 302 to transmit information to the finisher 120 through the communication I/F unit 301 based on the inspection results stored in the RAM 303. The information transmitted to the finisher 120 includes information on whether there is a defect in the printed material. The finisher 120 uses the received information and discharges a non-defective printed material to a normal output tray and a defective printed material to an escape tray different from the normal output tray.

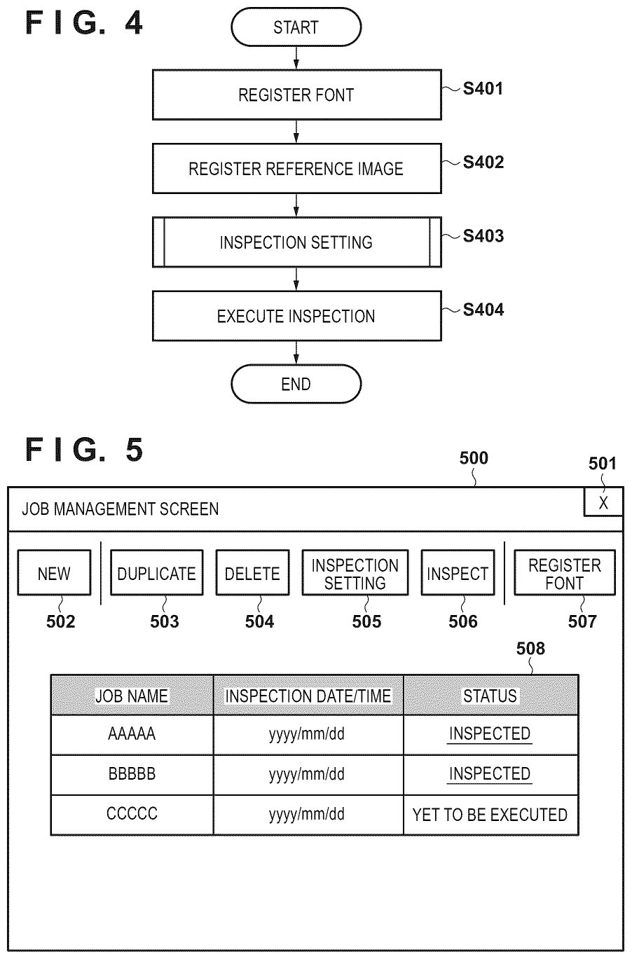

Next, a flow of the entire processing from registration work before the start of inspection to execution of inspection in the inspection apparatus 110 according to the first embodiment will be described with reference to the flowchart of FIG. 4.

FIG. 4 is a flowchart for explaining a flow of inspection processing by the inspection apparatus 110 according to the first embodiment. The processing described in the flowchart is realized by the CPU 302 deploying program code stored in the ROM 304 to the RAM 303 and executing the program code.

In step S401, the CPU 302 registers a glyph font. The glyph font registered here is used at the time of data inspection. A glyph font is data necessary for character recognition (OCR) performed at the time of data inspection and in which glyph images of characters are associated with character codes.

In glyph font creation processing, the inspection apparatus 110 first waits in glyph font image read mode and receives a glyph font creation print job from the client PC 130. Upon receiving a glyph font job from the client PC 130, the image forming apparatus 100 prints a glyph font image on a sheet based on that glyph font job and discharges the printed sheet (printed material). Upon detecting a printed material printed and discharged by the image forming apparatus 100, the inspection apparatus 110 waiting in glyph font image read mode uses the image reading unit 310 to scan the printed material, obtains a scanned image thereof, and stores the scanned image in the RAM 303. Then, the inspection apparatus 110 cuts out, from the scanned image, each character of OCR target characters, and the user inputs, from the UI unit 320, character codes for the cutout character images, and a glyph font can thereby be created. A glyph font thus created is stored in the RAM 303 of the inspection apparatus 110. Here, a method of creating a glyph font according to the first embodiment has been described, but the method is not limited thereto and may be any method so long as data in which each character image cut out from a scanned image is associated with a character code can be created. Since it is possible to not perform data inspection and perform only printed image inspection, a configuration may be taken so as to, in the case of only performing printed image inspection, skip the processing of step S401 and transition to step S402.

In step S402, the CPU 302 registers a reference image, which serves as a correct image in inspection. At this time, the image forming apparatus 100 and the inspection apparatus 110 wait in reference image read mode, and the image forming apparatus 100 receives a reference image registration print job from the client PC 130 and executes the reference image registration print job. The image forming apparatus 100 thus prints and discharges a reference image. Upon detecting conveyance of a printed material on which the reference image has been printed, the inspection apparatus 110 waiting in reference image read mode uses the image reading unit 310 to scan that printed material and obtains a scanned image of the reference image. Then, that scanned image is stored in the RAM 303 of the inspection apparatus 110 as the reference image, and the reference image is thereby registered.

In the first embodiment, a printed material on which a reference image has been printed is scanned by the image reading unit 310, and the reference image is thereby registered, but the present invention is not limited thereto. For example, the method may be that in which image data subjected to RIP processing by the print server 140 or by the image processing unit 205 of the image forming apparatus 100 is registered as the reference image.

Next, the processing proceeds to step S403, and the CPU 302 stores various inspection setting values for an inspection region, an inspection level, and the like in the RAM 303 of the inspection apparatus 110 according to inspection setting through the UI unit 320 by the user. The processing of step S403 according to the first embodiment will be described later in detail. Here, the inspection level represents the inspection level based on the required quality of printed material.

Next, the processing proceeds to step S404, and the CPU 302 executes inspection processing based on an inspection job from the client PC 130. In this inspection processing, upon detection of conveyance of a printed material, the printed material is scanned by the image reading unit 310, and the obtained scanned image is stored in the RAM 303 of the inspection apparatus 110. Then, printed image inspection is performed using the scanned image, the reference image registered in step S402, and the setting values set by inspection setting in step S403. If the inspection job includes data inspection, data inspection is executed using the glyph font registered in step S401 and the inspection setting values set in step S403. Then, the CPU 302 notifies the CPU 202 of the image forming apparatus 100 of the inspection result, and the CPU 202 switches discharge control of the finisher 120 according to the inspection result. In a case where the inspection result is OK, the printed material is discharged to the tray 1 (not illustrated), and in a case where the inspection result is NG, the printed material is discharged to the tray 2 (not illustrated). In the present embodiment, the method of switching the discharge destination according to OK/NG of the inspection result is described, but for example, control may be performed so as to switch the discharge destination according to the inspection content. For example, discharge destinations may be allocated to a plurality of trays according to OK/NG for each inspection level. In addition, the discharge destination may be switched according to OK/NG of printed image inspection and OK/NG of data inspection. For example, an inspection OK printed material may be discharged to the tray 1 (not illustrated), a printed image inspection NG printed material may be discharged to the tray 2 (not illustrated), and a data inspection NG printed material may be discharged to a tray 3 (not illustrated). Then, the processing indicated by the flowchart is terminated.

FIG. 5 is a diagram illustrating an example of a job management screen 500 to be displayed on the UI unit 320 of the inspection apparatus 110 according to the first embodiment.

The job management screen 500 is displayed when the inspection apparatus 110 is started or is displayed when an application is started by the user operation from the UI unit 320. From the job management screen 500, transitions to respective processes of font registration, reference image registration, inspection setting, and inspection can be made according to a user operation.

A close button 501 is a button for clearing (closing) display of the screen 500. A new button 502 is a button for creating a new inspection job, and by the new button 502 being pressed, the processing proceeds to registration of a reference image. A duplicate button 503 is a button for duplicating an already created inspection job. When an inspection job is selected in an inspection job list 508 and the duplication button 503 is pressed, the selected inspection job is duplicated. By thus duplicating an inspection job, it is possible to create a new inspection job with the reference image and inspection settings duplicated and execute the new inspection job. A delete button 504 deletes an inspection job selected in the inspection job list 508. Here, by selecting a plurality of inspection jobs in the inspection job list 508 and pressing the delete button 504, a plurality of inspection jobs can be deleted simultaneously.

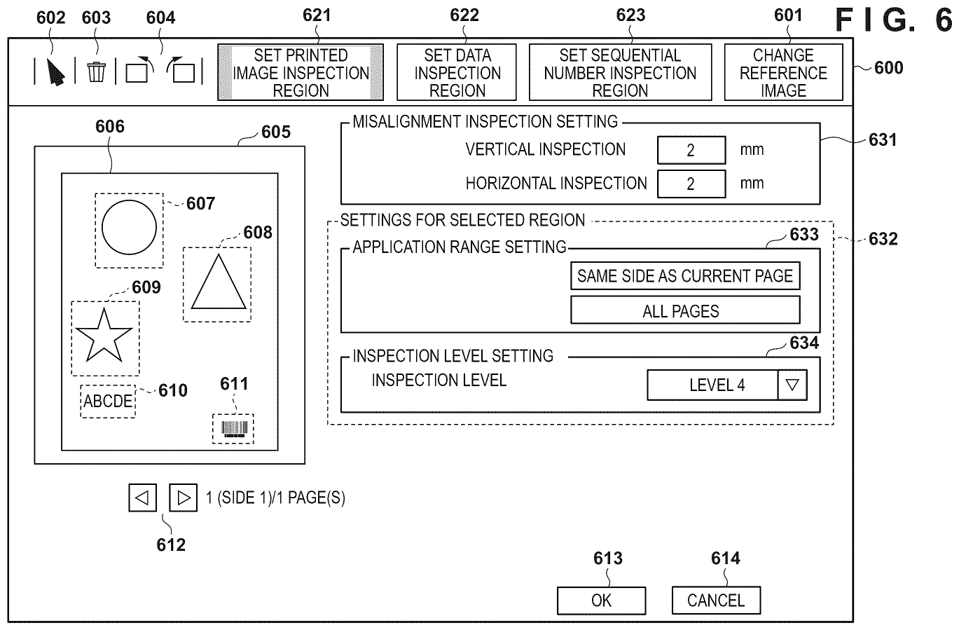

An inspection setting button 505 performs inspection setting for an inspection job for which registration of a reference image has been completed. The inspection setting is performed in step S403 of FIG. 4. Transition to the inspection setting screen illustrated in FIG. 6 is made when the inspection setting button 505 is pressed. An inspection button 506 is a button for instructing to perform inspection according to an inspection job for which registration of a reference image and inspection settings have been completed. A font registration button 507 registers the above glyph font.

Next, inspection setting will be described with reference to FIG. 6.

FIG. 6 is a diagram illustrating an example of an inspection setting screen 600 to be displayed on the UI unit 320 of the inspection apparatus 110 according to the first embodiment.

A reference image change button 601 is pressed when it is desired to change a registered reference image. A button 602 is a button for selecting an inspection region and is pressed by the user when it is desired to select an already set inspection region. A button 603 is a button for deleting an inspection region and is pressed by the user when it is desired to delete an inspection region selected using the button 602. Buttons 604 are buttons for rotating a reference image 606 displayed in a region 605.

The region 605 is a display region for displaying a read reference image. If there are a plurality of read reference images, the displayed reference image is switched using buttons 612. The front and back of a read sheet can also be switched using the buttons 612.

An OK button 613 is a button for storing settings of the inspection setting screen 600 and transitioning to the job management screen 500 illustrated in FIG. 5. A configuration may be taken such that a press of the OK button 613 allows transition to an inspection screen (not illustrated) and execution of inspection. A cancel button 614 is a button for transitioning to the job management screen 500 illustrated in FIG. 5 without storing settings of the inspection setting screen 600.

A button 621 is a button pressed by the user when setting a new inspection region for printed image inspection. After pressing the button 621, the operator can set an inspection region on the reference image 606 displayed in the region 605. Regions 607, 608, 609, 610, and 611 indicate examples of inspection regions for printed image inspection that have been set.

A button 622 is a button pressed by the user when setting a new character inspection or barcode inspection region as a data inspection region. After pressing the button 622, the user can set an inspection region for data inspection on the reference image 606 displayed in the region 605. A button 623 is a button pressed by the user when setting a new sequential number inspection region. After pressing the button 623, the user can set an inspection region for sequential number inspection on the reference image 606 displayed in the region 605. In the sequential number inspection, data inspection is performed based on a predetermined rule. The predetermined rule includes a start number, an end number, an increase or decrease value, and the like.

A setting item 631 is a setting for an allowable value for misalignment inspection and sets an allowable amount of misalignment in printing position from the reference image. In the first embodiment, an example in which the user has set to detect misalignment in which misalignment amounts in the respective vertical and horizontal directions are 2 mm or more as a defect is indicated. That is, a value set by the user here corresponds to a threshold for determining a defect in misalignment detection. If misalignment greater than or equal to a threshold (here, 2 mm or more) set here is detected, it will be determined to be an inspection NG.

A setting region 632 is a group of UIs for performing setting for an inspection region currently selected in the region 605. A setting item 633 sets an application range of the selected inspection region. If nothing is selected, the selected inspection region is arranged only on the page currently displayed in the region 605. If “same side as current page” is selected, the selected inspection region is arranged on pages of the same side depending on whether the selected inspection region is arranged on the front or back side of the sheet. If “all pages” is selected, the selected inspection region is arranged on all pages included in the inspection job.

A setting item 634 is a setting for an inspection level and sets an inspection level for the selected inspection region. An inspection level is a parameter set in levels for each feature of a detected defect as to the size from which something is determined to be a defect. For example, there are nine levels from level 1 to level 9, where level 9 is stricter than level 1 and can detect defects of a thinner and smaller size.

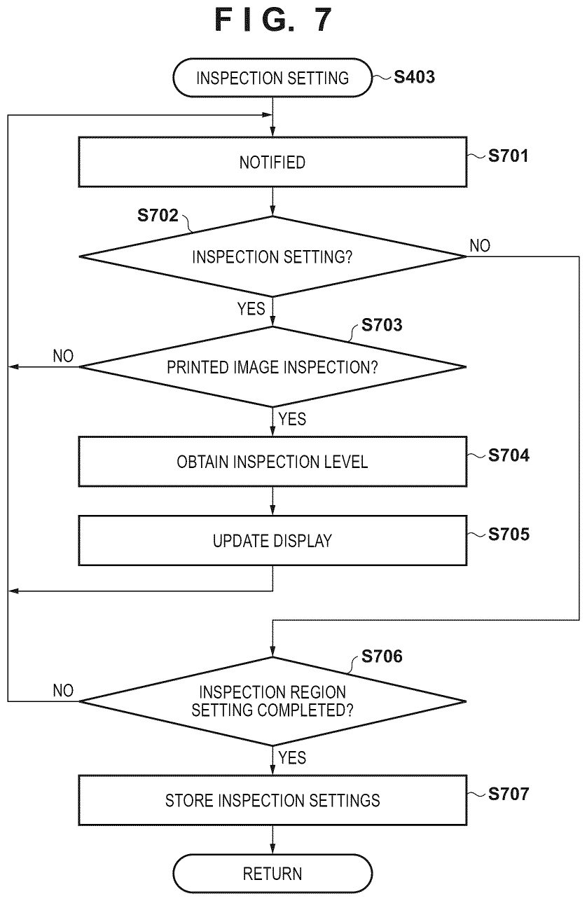

Next, the inspection setting processing of step S403 will be described with reference to the flowchart of FIG. 7.

FIG. 7 is a flowchart for explaining the inspection setting processing of step S403 of FIG. 4. The processing described in the flowchart is realized by the CPU 302 of the inspection apparatus 110 deploying program code stored in the ROM 304 to the RAM 303 and executing the program code.

In step S701, the CPU 302 receives a notification of a user UI operation from the UI unit 320. Next, the processing proceeds to step S702, and the CPU 302 determines whether inspection setting has been performed. Specifically, it is determined whether a new inspection region has been set or settings for an already set inspection region have been changed. If it is determined that inspection setting has been performed, the processing proceeds to step S703, and if it is determined that an operation other than inspection setting has been performed, the processing proceeds to step S706.

In step S703, the CPU 302 determines whether an inspection region for which inspection setting has been performed in step S702 is an inspection region for printed image inspection. If it is determined to be the inspection region for printed image inspection, the processing proceeds to step S704, and if it is determined not to be the inspection region for printed image inspection, the processing returns to step S701 and a notification of a UI operation is awaited. In step S704, the CPU 302 obtains inspection level information corresponding to the inspection region determined in step S703 and stored in the RAM 303. Then, the processing proceeds to step S705, and the CPU 302 updates display of the inspection region based on the inspection level obtained in step S704.

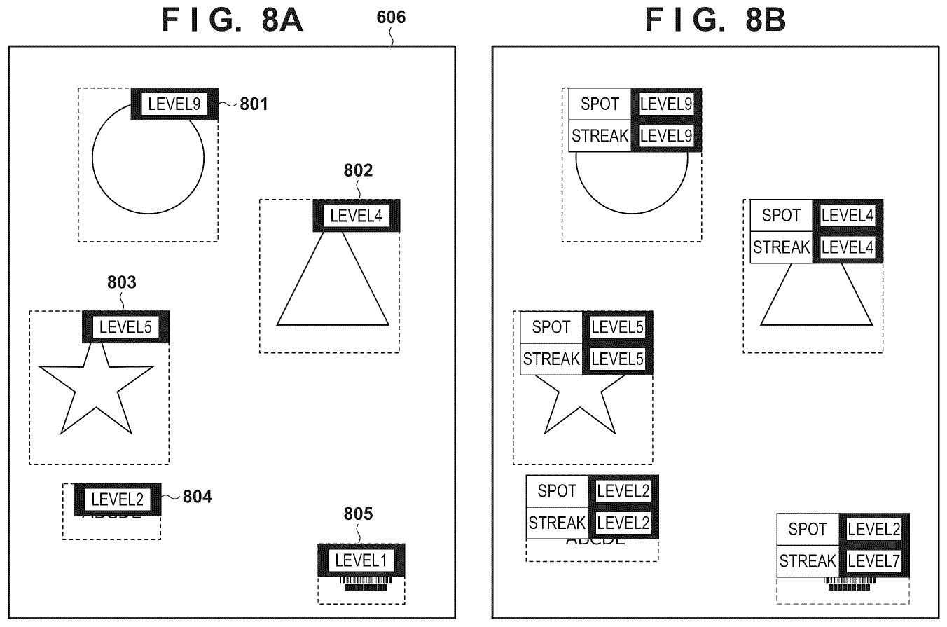

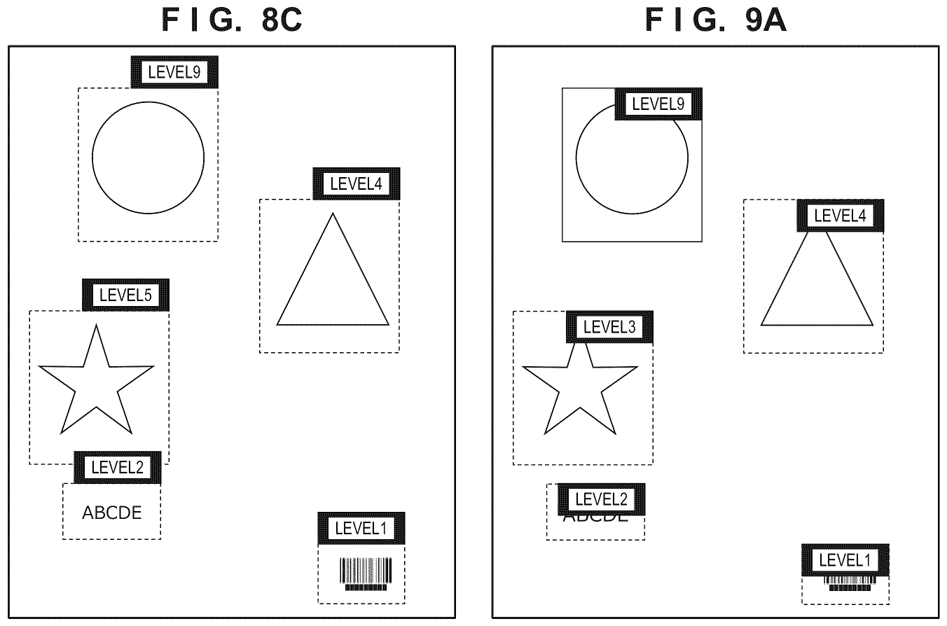

FIGS. 8A to 8C are diagrams illustrating examples of inspection regions in a reference image to be displayed in the region 605 of the inspection setting screen 600 of FIG. 6 and, here, illustrates an example of display in which a plurality of inspection regions having different inspection levels from each other are set in printed image inspection.

In printed image inspection, required quality may change depending on the portion where a stain is left. For example, although it is desired to detect stains of a certain size (e.g., about 0.5 mm) with a global inspection level, since stains left on an image of a person are noticeable, it may be desirable to detect small stains. Therefore, it is desirable that the inspection level can be set according to content to be printed. However, when a plurality of inspection regions having different inspection levels from each other are arranged, it is difficult to distinguish which inspection level is applied to each inspection region.

An example of display in which a region 801 indicated in FIG. 8A is set to inspection level 9, a region 802 is set to inspection level 4, an inspection region 803 is set to inspection level 5, an inspection region 804 is set to inspection level 2, an inspection region 805 is set to inspection level 1 is illustrated. Here, inspection level information is displayed on the reference image in a superimposed manner on the upper right of each inspection region. By thus displaying a corresponding inspection level on each inspection region, it is possible to easily confirm at which inspection level each inspection region will be inspected.

FIG. 8B illustrates an example of display of inspection regions for when printed image inspection allows setting of an inspection level for each type, such as circular defect (spot) and linear defect (streak), in the inspection setting screen 600 of FIG. 6. Here, an example in which, for each type of defect, set inspection level information is displayed in a superimposed manner on the upper portion of each inspection region, is illustrated.

Further, in FIGS. 8A and 8B, inspection level information is displayed in the frames of respective inspection regions set in FIG. 6, but for example, inspection level information may be displayed outside the frames of inspection regions, as illustrated in FIG. 8C. That is, inspection level information need only be displayed in positions near respective inspection regions where association therewith can be confirmed.

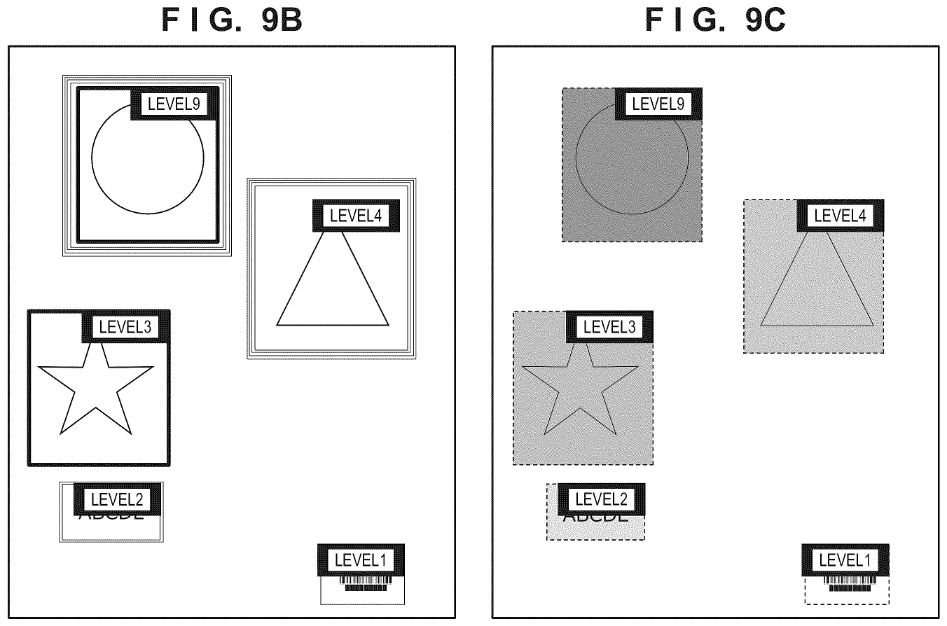

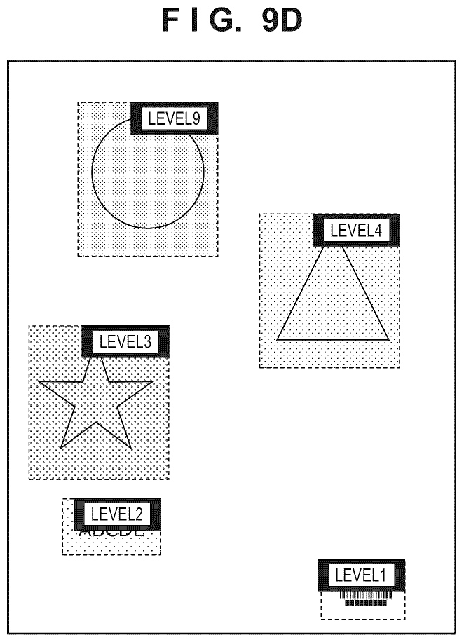

FIGS. 9A to 9D are diagrams illustrating examples of cases where, in addition to displaying inspection level information in a superimposed manner on the upper right of inspection regions, the frames of inspection regions and the display forms of inspection regions are changed according to the inspection levels, in the first embodiment.

FIG. 9A illustrates an example in which the density of the frame line of an inspection region is changed according to the inspection level. In the example of FIG. 9A, an example in which the lower the inspection level, the smaller the proportion of black segments in the dashed line indicating the frame line, and the higher the inspection level, the higher the proportion of black segments is illustrated. Specifically, the frame of an inspection region of level 1 is represented using a dashed line, and the frame of an inspection region of level 2 is represented using a broken line with slightly longer black segments. The frame of an inspection region of level 3 is a dash-dotted line, the frame of an inspection region of level 4 is represented using a dashed line with black segments longer than black segments of the frame for level 3, and the frame of an inspection region of level 9 is represented using a solid line. However, the present invention is not limited thereto, and a configuration may be taken so as to perform display in which, for example, the proportion of black segments is decreased as the inspection level decreases.

FIG. 9B illustrates an example in which the number of frame lines of an inspection region is changed according to the inspection level. Here, although the number of frame lines is increased as the inspection level increases, the present invention is not limited thereto. For example, a configuration may be taken so as to perform display in which the number of frame lines is increased as the inspection level decreases. When the number of set inspection levels is large, a configuration may be taken so as to perform display with a different thickness of the frame line for each predetermined level. FIG. 9B illustrates an example in which, for inspection level 3, the frame line is represented using a bold line instead of three lines.

FIG. 9C illustrates an example in which the frames of the inspection regions are dashed lines and a transmittance inside an inspection region is changed according to the inspection level. In FIG. 9C, the transmittance is decreased as the inspection level increases, and the transmittance is increased as the inspection level decreases. However, the present invention is not limited thereto, and a configuration may be taken so as to perform display in which, for example, the transmittance is decreased as the inspection level decreases.

FIG. 9D illustrates an example in which the frames of the inspection regions are dashed lines and a ratio for halftone dots inside an inspection region is changed according to the inspection level. Here, a halftone dot ratio is expressed by drawing a dot pattern or the like inside an inspection region and changing the size of a black pixel of the dot pattern. The size of a black pixel of the dot pattern is increased as the halftone dot ratio increases. FIG. 9D illustrates an example in which the halftone dot ratio is increased as the inspection level increases, and the halftone dot ratio is decreased as the inspection level decreases. However, the present invention is not limited thereto, and a configuration may be taken so as to perform display in which, for example, the halftone dot ratio is increased as the inspection level decreases.

The frames of inspection regions and the display forms of inspection regions are not limited to the above examples, and any display form may be taken so long as an inspection level can be recognized by a stepwise change according to the inspection level. The display form is not limited to one of these, and an inspection level may be displayed by combining a plurality of display forms.

As described above, in addition to superimposed display of inspection level information described in FIGS. 8A to 8C, by changing the display form of an inspection region and the frame of an inspection region according to the inspection level as illustrated in FIGS. 9A to 9D, it becomes possible to easily recognize at which inspection level each inspection region will be inspected. The description of FIG. 7 will be returned to again.

In step S705, the CPU 302 changes the display form according to the inspection level and then returns to step S701 and waits for a notification of a UI operation.

In step S702, if input is not inspection setting, the processing proceeds to step S706, and the CPU 302 determines whether setting of inspection regions has been completed. Here it is determined whether the OK button 613 illustrated in FIG. 6 has been pressed. If it is determined that the OK button 613 has been pressed, it is determined that inspection setting has been completed and the processing proceeds to step S707. Meanwhile, if it is determined in step S706 that the OK button has not been pressed, the processing returns to step S701 and a notification of a UI operation is awaited. In step S707, the CPU 302 stores the setting values set in the inspection setting screen 600 in the RAM 303 and terminates the processing. This concludes the description related to a flow of inspection setting of step S403.

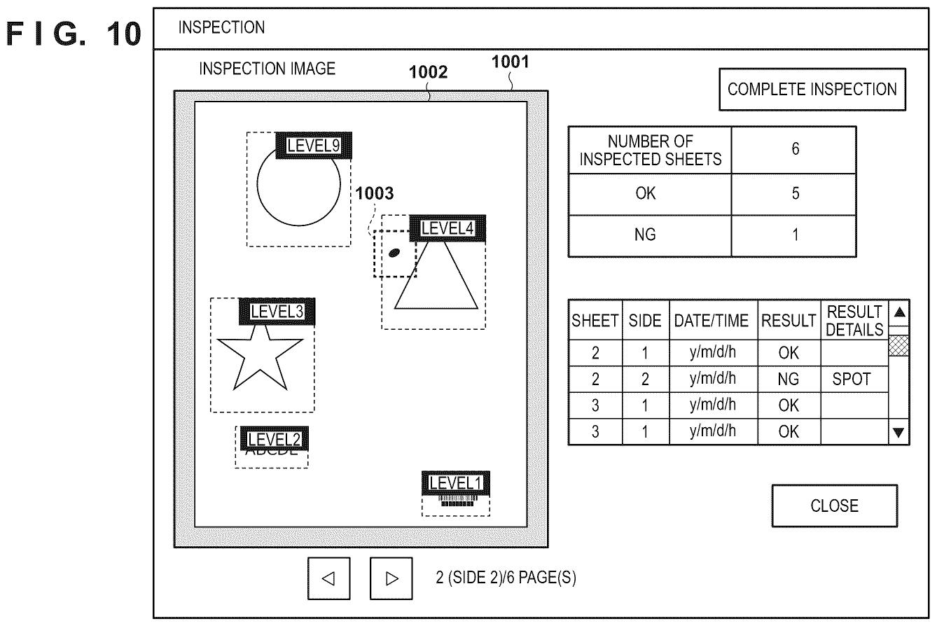

FIG. 10 is a diagram illustrating an example of an inspection result confirmation screen to be displayed after inspection execution of step S404 has been completed in the first embodiment.

A region 1001 is a display region for displaying a read inspection image 1002. A region 1003 indicates a region where a defect has been detected. By displaying inspection regions and inspection levels in a superimposed manner on the inspection image also in the inspection result confirmation screen, it is possible to easily distinguish at which inspection level a region where a defect has been detected has been inspected.

In the first embodiment, examples of display in the inspection setting screen and the inspection result confirmation screen have been described, but the present invention is not limited thereto, and for example, a configuration may be taken so as to display inspection levels and inspection regions using such a display form when displaying an image in a file such as an inspection report.

As described above, according to the first embodiment, there is an advantageous effect that, even when a plurality of inspection regions having different inspection levels from each other are arranged, it is possible to easily distinguish which inspection level is set for each inspection region.

### Second Embodiment

In the above first embodiment, an example in which, even when a plurality of regions having different inspection levels from each other are arranged, it is possible to easily distinguish which inspection level is applied to each inspection region has been described. However, in the method of the first embodiment, performing display in which display of inspection level information, the frames of inspection regions, and the display forms of inspection regions are changed may result in difficulty in confirming the image portions of the reference image and the inspection image. Therefore, in the second embodiment, an example in which it is possible to change the presence of display and the display position of the inspection level information and change the display form will be described. Since the configurations and the like of the system and apparatus according to the second embodiment are the same as those of the above first embodiment, description thereof will be omitted.

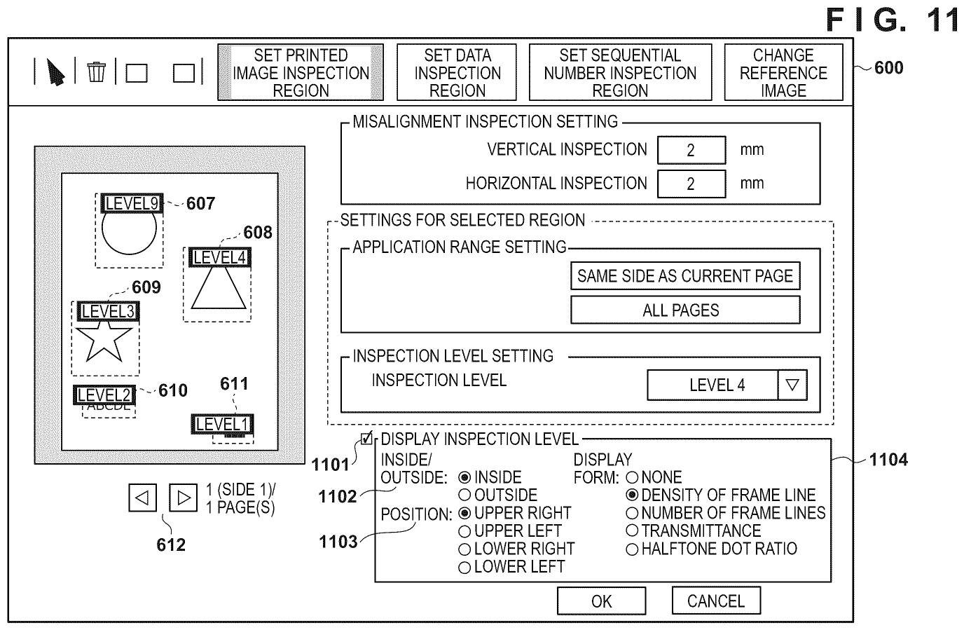

FIG. 11 is a diagram illustrating an example of the inspection setting screen 600 to be displayed on the UI unit 320 of the inspection apparatus 110 according to the second embodiment.

A radio button 1101 is a button for switching display of the inspection level on/off, and when checked, it is possible to turn the inspection level information on/off and change the display form. When the check of the radio button 1101 is removed, the inspection level information is no longer displayed and the portion of the reference image that had been obscured by the inspection level information can be confirmed.

A setting item 1102 is an item for selecting to display the inspection level information inside or outside the inspection region. When the inspection level information is selected to be displayed inside the inspection region, the inspection level information is displayed inside the inspection region as in FIG. 8A, for example. When the inspection level information is selected to be displayed outside, the inspection level information is displayed outside the inspection region in contact with or in proximity to the inspection region as in FIG. 8C, for example.

A setting item 1103 is an item for selecting which among the upper right, upper left, lower right, or lower left of the inspection region to display the inspection level information.

By thus changing the display position of the inspection level information using the setting item 1102 and the setting item 1103, it is possible to confirm the portion of the reference image that had been obscured by the inspection level information.

A setting item 1104 is a setting item for switching the display form of the inspection region. When “none” is selected here, the display form is not changed according to the inspection level. In FIG. 11, “density of frame line” is selected, in which case a display form in which the density of black segments of the frame line of the inspection region varies depending on the inspection level, as illustrated in FIG. 9A, for example, is assumed. Further, when “number of frame lines” is selected, a display form in which the number or thickness of the frame line of the inspection region varies depending on the inspection level, as illustrated in FIG. 9B, for example, is assumed. Further, when “transmittance” is selected, a display form in which the transmittance of the inspection region varies depending on the inspection level, as illustrated in FIG. 9C, for example, is assumed. Further, when “halftone dot ratio” is selected, a display form in which the size of a black pixel of the dot pattern of an inspection region varies depending on the inspection level, as illustrated in FIG. 9D, for example, is assumed. By thus switching the display form of the inspection region by using the setting item 1104, it is possible to easily distinguish between the inspection levels of respective inspection regions and switch to the display in which the reference image is easily confirmed.

As described above, according to the second embodiment, it is possible to perform display in which display of the inspection level information, the frame of the inspection region, and the display form of the inspection region are changed. Thus, even when it is difficult to confirm the image portions of the reference image and the inspection image due to the inspection level information being displayed, by switching the display, it is possible to easily confirm the reference image and the inspection image.

### Third Embodiment

In the first embodiment, an example in which, even when a plurality of inspection regions having different inspection levels from each other are arranged, it is possible to easily distinguish which inspection level is set to each inspection region has been described. However, in the method of the first embodiment, in a case where, for example, the number of inspection levels that have actually been set is small relative to the number of inspection levels that can be set and only inspection regions whose inspection levels are close are set, it is difficult to distinguish between the inspection levels. Therefore, in the third embodiment, an example of changing the display form of the inspection region according to the number of inspection levels that have been set will be described. Since the configurations and the like of the system and apparatus according to the third embodiment are the same as those of the above first embodiment, description thereof will be omitted.

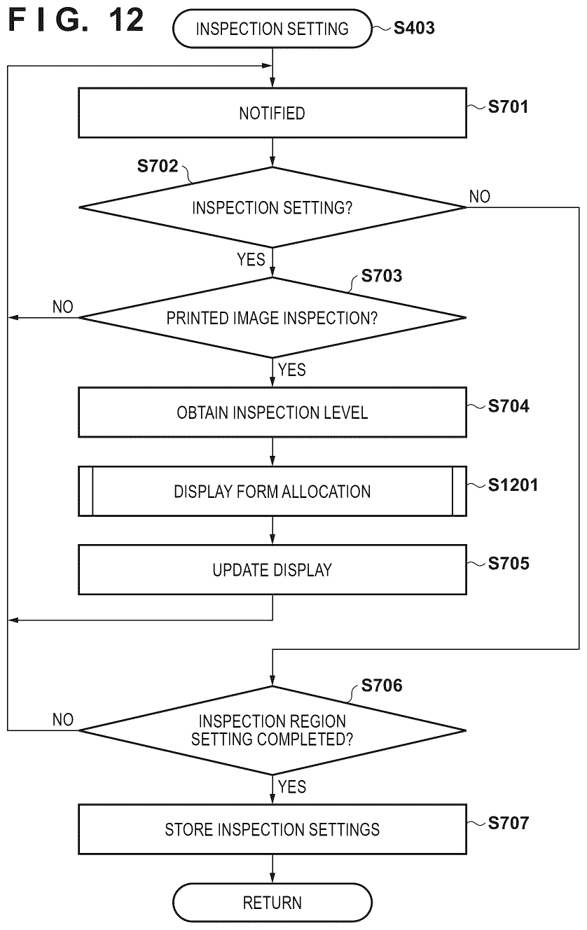

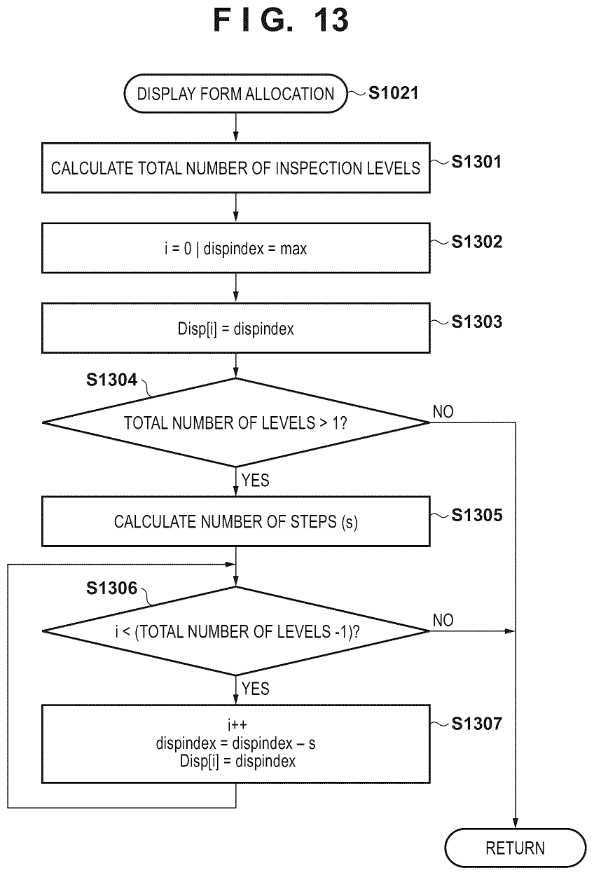

A flow of inspection setting in the third embodiment will be described with reference to flowcharts of FIGS. 12 and 13.

FIG. 12 is a flowchart for explaining the inspection setting processing of step S403 according to the third embodiment. The processing described in the flowchart is realized by the CPU 302 of the inspection apparatus 110 deploying program code stored in the ROM 304 to the RAM 303 and executing the program code. In FIG. 12, the same processes as those indicated in above FIG. 7 are denoted by the same reference numerals, and description thereof will be omitted.

In step S704, upon obtaining the inspection level information corresponding to the determined inspection region, the processing proceeds to step S1201, and the CPU 302 performs allocation of display forms based on the number of inspection levels that have been set.

FIG. 13 is a flowchart for explaining display form allocation processing in step S1201 of FIG. 12.

In step S1301, the CPU 302 calculates the total number of inspection levels set on the inspection setting screen 600. For example, in a case where the inspection region 1 is set to inspection level 3, the inspection region 2 is set to inspection level 5, the inspection region 3 is set to inspection level 8, and the inspection region 4 is set to inspection level 3, the total number of inspection levels is three: inspection level 3, inspection level 5, and inspection level 8. Here the total number of inspection levels is the total number in one page being displayed, but a configuration may be taken so as to perform calculation using, for example, the total number of inspection levels in the entire inspection job.

Next, the processing proceeds to step S1302, and the CPU 302 initialize an index i and dispindex indicating the identification number of the display form. At this time, the default value of dispindex is a maximum value max. The index i and the identification number dispindex are stored in the RAM 303.

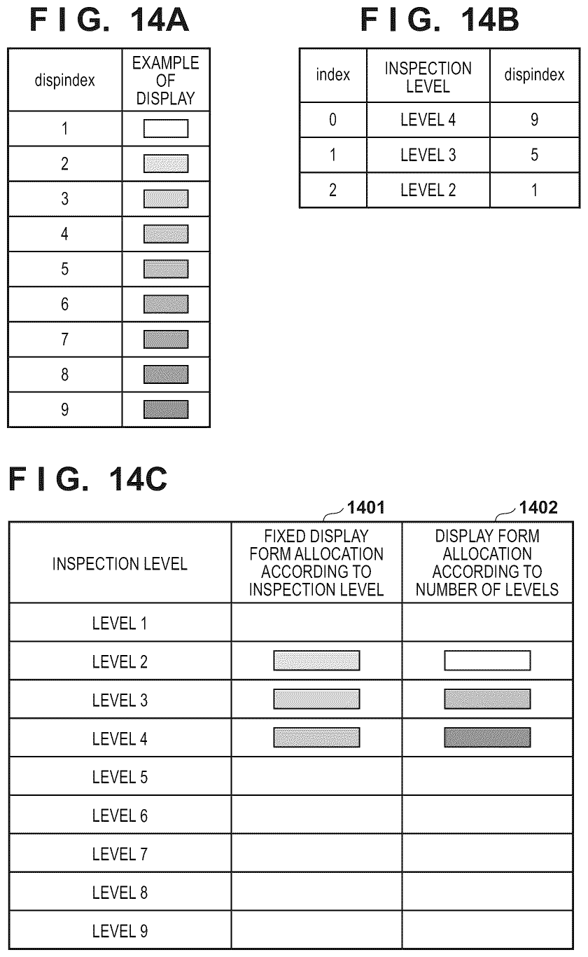

FIGS. 14A to 14C are diagrams illustrating examples of allocation of display forms of inspection regions according to the third embodiment.

FIG. 14A illustrates examples of display form patterns in which the transmittance is changed for each inspection level. The number of patterns in the display form of FIG. 14A is nine levels from 1 to 9, and the patterns of transmittance to be displayed are associated with the identification numbers dispindex of the display forms. In this example, the maximum value max is “9”.

Next, the processing proceeds to step S1303, and the CPU 302 assign dispindex in an inspection level and display form association table Disp[i]. The table Disp is also stored in the RAM 303.

FIG. 14B illustrates an example of an association table. FIG. 14B illustrates an example of the display form association table Disp[i] for when three types, which are inspection level 4, inspection level 3, and inspection level 2, are set and the total number of levels is “3”. In this example, in step S1302, dispindex=9 is set in Disp[0].

Next, the processing proceeds to step S1304, and the CPU 302 determines whether the total number of inspection levels calculated in step S1301 is greater than 1. Here, if it is determined to be greater than 1, the processing proceeds to step S1305, and if it is determined to be 1 or less, the processing is terminated. In step S1305, the CPU 302 calculates the number of steps s. Here, the number of steps s indicates the intervals for displaying the display patterns illustrated in FIG. 14A. The step s is calculated by (maximum number of inspection levels−1)/(total number of inspection levels−1), and digits after the decimal point are rounded up. In the third embodiment, in a case where the maximum number of inspection levels=9 and the total number of inspection levels=3, the step s will be 4 based on (9−1)/(3−1)=4.

Next, the processing proceeds to step S1306, and the CPU 302 determines whether the index i is less than (total number of inspection levels−1). That is, here, it is determined whether the index i is less than (3−1=)2. If it is determined that the index i less than (total number of levels of inspection levels−1), the processing proceeds to step S1307. Meanwhile, if it is determined that the index i is (total number of inspection levels−1) or more, it is determined that allocation of the display form for all the inspection levels has been completed, and the processing is terminated.

In step S1307, the CPU 302 increments the index i, allocates a display form to the next inspection level, and returns to step S1306. In step S1307, the number of steps s is subtracted from dispindex and dispindex is updated. In the third embodiment, when i=1, dispindex=9(maximum value)−4(s)=5 and Disp[1]=5 is set, as illustrated in FIG. 14B. When i=2, dispindex=5−4=1 and Disp[2]=1 is set.

FIG. 14C is a diagram illustrating comparison of an example in which a fixed display form is allocated according to the inspection level with allocation of a display form according to the third embodiment.

A reference numeral 1401 indicates a case where a fixed display forms are allocated according to the inspection levels. A reference numeral 1402 indicates an example in which display forms are allocated according to the number of levels by using the method in the third embodiment. By thus increasing the display step (difference) of the pattern of the display form per inspection level when the total number of inspection levels is less than the maximum number of inspection levels, it is possible to more easily distinguish between the inspection levels.

As described above, according to the third embodiment, by changing the display form of the inspection region according to the total number of inspection levels that have been set so as to make them easier to distinguish, there is an advantageous effect that it is possible to easily distinguish between the inspection levels.

### OTHER EMBODIMENTS

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-052130, filed Mar. 27, 2024, which is hereby incorporated by reference herein in its entirety.

What is claimed is:

1. An inspection apparatus comprising:
one or more controllers including one or more processors and one or more memories, the one or more controllers configured to:
obtain a scanned image obtained by reading a printed material with an image reading unit;
inspect the printed material based on the scanned image and a reference image;
set an inspection region to be a target of the inspection and an inspection level for the inspection region; and
display a first inspection region, for which a first inspection level has been set in the setting, so as to be surrounded by a frame line of a first thickness, and display a second inspection region, for which a second inspection level different from the first inspection level has been set in the setting, so as to be surrounded by a frame line of a thickness different from the first thickness.

2. The inspection apparatus according to claim 1, wherein in the setting of the inspection region and the inspection level, the one or more controllers set the inspection region on the reference image.

3. The inspection apparatus according to claim 2, wherein in the setting, the one or more controllers are capable of setting a plurality of inspection regions on the reference image and, in a case where a plurality of inspection regions are set, set an inspection level for an inspection region selected from the plurality of inspection regions.

4. The inspection apparatus according to claim 1, wherein in the setting of the inspection region and the inspection level, the one or more controllers are further capable of setting the inspection level in association with a type of defect to be an inspection target.

5. The inspection apparatus according to claim 1, wherein in the display of the first inspection region and the second inspection region, the one or more controllers perform display so as to vary a density of a frame line of the first inspection region and a density of a frame line of the second inspection region.

6. The inspection apparatus according to claim 1, wherein in the display of the first inspection region and the second inspection region, the one or more controllers perform display so as to vary the number of frame lines of the first inspection region and the number of frame lines of the second inspection region.

7. The inspection apparatus according to claim 1, wherein in the display of the first inspection region and the second inspection region, the one or more controllers perform display so as to vary a transmittance of the first inspection region and a transmittance of the second inspection region.

8. The inspection apparatus according to claim 1, wherein in the display of the first inspection region and the second inspection region, the one or more controllers perform display so as to vary a halftone dot ratio of the first inspection region and a halftone dot ratio of the second inspection region.

9. The inspection apparatus according to claim 1, wherein the one or more controllers are further capable of selecting whether to vary a display form of a frame of the first inspection region and a display form of a frame of the second inspection region.

10. The inspection apparatus according to claim 5, wherein in the display of the first inspection region and the second inspection region, the one or more controllers further change a display step of a display form of a frame of the inspection region or a transmittance or a halftone dot ratio of the inspection region, for one inspection level, based on a maximum number of inspection levels that can be set for inspection regions and a total number of inspection levels set for the inspection regions that have been set.

11. A method of controlling an inspection apparatus configured to receive a printed material and perform inspection, the method comprising:
obtaining a scanned image obtained by reading a printed material with an image reading unit;
inspecting the printed material based on the scanned image and a reference image;
setting an inspection region to be a target of the inspection and an inspection level for the inspection region; and
displaying a first inspection region, for which a first inspection level has been set in the setting, so as to be surrounded by a frame line of a first thickness, and displaying a second inspection region, for which a second inspection level different from the first inspection level has been set in the setting, so as to be surrounded by a frame line of a thickness different from the first thickness.

12. An inspection apparatus comprising:
one or more controllers including one or more processors and one or more memories, the one or more controllers configured to:
obtain a scanned image obtained by reading a printed material with an image reading unit;
inspect the printed material based on the scanned image and a reference image;
set an inspection region to be a target of the inspection and an inspection level for the inspection region; and
display information of a first inspection level near a first inspection region, for which the first inspection level has been set in the setting, and display information of a second inspection level near a second inspection region, for which the second inspection level has been set in the setting.

13. The inspection apparatus according to claim 12, wherein in the display, the one or more controllers display the information of the first inspection level on the first inspection region in a superimposed manner.

14. The inspection apparatus according to claim 12, wherein in the display, the one or more controllers display the information of the first inspection level in contact with or in proximity to a frame of the first inspection region and outside the first inspection region.

15. The inspection apparatus according to claim 12, wherein the one or more controllers is further capable of selecting whether to set an area in which the information of the first inspection level is displayed to be inside the first inspection region or outside the first inspection region.

16. The inspection apparatus according to claim 12, wherein the one or more controllers is further capable of selecting whether to set an area in which the information of the first inspection level is displayed to be upper right, lower right, upper left, or lower left of the first inspection region.
